(19) United States
(12) Patent Application Publication
(10) Pub. No.: US 2025/0306549 A1
(43) Pub. Date: Oct. 2, 2025

(54) METHOD AND DIGITAL TWIN SYSTEM FOR REAL-TIME MONITORING AND PREDICTION OF TUBE BENDING PROCESS STATE

(71) Applicant: ZHEJIANG UNIVERSITY, Hangzhou (CN)

(72) Inventors: Zili WANG, Hangzhou (CN); Jie LI, Hangzhou (CN); Shuyou ZHANG, Hangzhou (CN); Jianrong TAN, Hangzhou (CN)

(21) Appl. No.: 19/238,327

(22) Filed: Jun. 13, 2025

Related U.S. Application Data
(63) Continuation of application No. PCT/CN2024/124157, filed on Oct. 11, 2024.

(30) Foreign Application Priority Data
Dec. 28, 2023 (CN) 202311832024.9

(51) Int. Cl. G05B 13/04; B21C 51/00

(52) U.S. Cl. CPC G05B 13/048; B21C 51/00

(57) ABSTRACT

Disclosed is a method and digital twin system for real-time monitoring and prediction of tube bending process state. By mounting gyroscopes and force sensors in tube bending devices, bending dies, pressing dies and other dies, the data of position, speed and acceleration of each die, as well as pressure and friction between each die and tube fittings can be acquired in real time. In the present disclosure, the acquisition of bending state of the tube bending device die and the tube fitting can be realized, and the real-time monitoring and prediction of bending process state can be realized, thereby improving the accuracy of tube bending device and the quality of tube bending.

### CROSS-REFERENCE TO RELATED APPLICATIONS

This application is a continuation of PCT/CN2024/124157, filed on Oct. 11, 2024 and claims priority of Chinese Patent Application No. 202311832024.9, filed on Dec. 28, 2023, the entire contents of which are incorporated herein by reference.

### TECHNICAL FIELD

The present disclosure relates to the field of digital twins, and in particular to a method and a digital twin system for real-time monitoring and prediction of a tube bending process state.

### BACKGROUND

Tube bending components are made of straight hollow tube fittings bent by a tube bending device under the coupling action of various dies, and are widely used in high-tech fields including aviation and aerospace. The tube bending device with the highest accuracy and the most widely used is the bending forming computer numerical control (CNC) tube bending device included by bending die, clamping die, pressing die, anti-wrinkle die, core shaft and other dies. However, the traditional bending method presents an open-loop control method, which lacks intelligence, and it is impossible to obtain the actual running state of the tube bending device die and the deformation process data of the tube fitting in the tube fitting bending process. In order to obtain tube fittings with higher forming quality, it is necessary to rely on a large number of manual test bending, off-line measurement and other processes based on experience, which have low efficiency and difficult to guarantee accuracy.

The digital twin system is to establish a twin model in virtual space through physical geometry model, real-time state data, historical operation data, etc., complete the simulation evolution process of multi-time scales and multi-physics fields in the twin system, and conduct online guidance and regulation of actual scenes through the feedback system. With the application of digital twin system in process processing, how to realize the mapping of physical model to model in virtual space through data acquisition and predict future state through digital twin modeling has become an important basic work.

In order to realize the mapping from the actual physical process of the whole bending process of tube fittings to the virtual space twin model and the future state prediction, it is necessary to construct a reasonable data acquisition system to realize the online real-time state monitoring and future state prediction of the die state of tube bending device and the bending process of tube fittings. At present, the digital twin model of machining process only models device or workpiece, and the state monitoring and future state of workpiece will be affected by the device state. The generalization ability of digital twin model will be weakened only by considering single dimension information. Therefore, a data acquisition method and digital twin system for real-time monitoring and prediction of a tube bending process state are proposed.

### SUMMARY

In order to solve the problems in the background, the present disclosure provides a method and digital twin system for real-time monitoring and prediction of a tube bending process state, which effectively realizes multi-directional online real-time monitoring and prediction of the die state of a tube bending device and a tube fitting bending process, can improve the intelligent level of the tube fitting bending process, and improve the bending forming quality of the tube fitting.

The technical solutions adopted by the present disclosure are as follows.
I. A digital twin system for real-time monitoring and prediction of a tube bending process state includes the following:
a tube bending device, a tube fitting, a data acquisition system, a data processing system and a twin model system. The data acquisition system is configured to acquire the state data of each die of the tube bending device and the deformation data of the tube fitting in a bending process of the tube fitting; the data processing system is configured to preprocess the data acquired by the data acquisition system; and the twin model system predicts the die state of the tube bending device and the bending state of the tube fitting at the current time and the future time according to the data preprocessed by the data processing system.

The tube bending device includes a bending die, an insert block, a clamping die, a pressing die, an anti-wrinkle die and a boosting trolley, a core shaft and core balls; a tail part of the tube fitting is clamped by a chuck of a boosting trolley, the other end of the tube fitting is clamped by the insert block and the clamping die, and a middle part is clamped by the pressing die and the anti-wrinkle die; the core balls and the core shaft for supporting a tube wall are arranged in the tube fitting, a plurality of core balls are connected in series and hinged on the core shaft, and the bending die are fixedly connected to the insert block; the bending die, the insert block and the clamping die rotate synchronously, torque is applied to the tube fitting through the synergistic effect of pressure and friction, and with the increase of rotation angle, the tube fitting is plastically deformed; in a bending process, the anti-wrinkle die and the core shaft remain stationary, and the plurality of core balls oscillate with the change of an axial shape of the tube fitting; and in the bending process, the pressing die and the boosting trolley move forward to provide forward power for the unbent part of the tube fitting through pressure and friction, thereby avoiding the failure of the tube fitting caused by defects including fracture and cross-section collapse.

The data acquisition system includes a tube bending device die state monitoring module and a tube fitting bending process monitoring module, state data of each die of the tube bending device is acquired by the tube bending device die state monitoring module, and the deformation data of the tube fitting in the bending process of the tube fitting is acquired by the tube fitting bending process monitoring module.

The data processing system includes a data filtering and denoising module, a time series preprocessing module, a tube bending process comprehensive information model and a historical information storage module.

The twin model system includes a spatio-temporal fusion transformation module based on multi-task learning and a twin model visual presentation module.

The tube bending device die state monitoring module includes:
a bending die gyroscope, embedded on a surface of the bending die, and configured to measure a rotation angle, bending speed and angular acceleration of the bending die;
a plurality of bending die temperature sensors, evenly distributed on the bending die and penetrating through the bending die up and down, and configured to measure a temperature of the bending die;
a clamping die force sensor, with a curved sensor induction surface, in which the sensor is embedded on an inner surface of the clamping die, that is, a contact surface with the tube fitting, and the sensor induction surface are completely fitted with the tube fitting; and the clamping die force sensor is configured to measure acting forces between the clamping die and the tube fitting, including a pressure between the clamping die and the tube fitting and a friction force between the clamping die and the tube fitting;
a pressing die gyroscope, embedded on a surface of the pressing die, and configured to measure a feed displacement, speed and acceleration of the pressing die;
a pressing die force sensor, with a curved sensor induction surface, in which the sensor is embedded on an inner surface of the pressing die, that is, a contact surface with the tube fitting, and the sensor sensing surface are completely fitted with the tube fitting; and the pressing die force sensor is configured to measure acting forces between the pressing die and the tube fitting, including a pressure between the pressing die and the tube fitting and a friction force between the pressing die and the tube fitting;
a plurality of pressing die temperature sensors, uniformly distributed on the pressing die and penetrating through the pressing die up and down, and configured to measure the temperature of the pressing die;
a boosting trolley gyroscope, embedded on an outer surface of the boosting trolley and configured to measure a feed displacement, speed and acceleration of the boosting trolley; and
a boosting trolley force sensor, with a curved sensor induction surface, in which the sensor is embedded on an inner surface of a chuck of the boosting trolley, that is, a contact surface with the tube fitting, and the sensor induction surface is completely fitted with the tube fitting; and the boosting trolley force sensor is configured to measure acting forces between the boosting trolley and the tube fitting, including a pressure between the boosting trolley and the tube fitting and a friction force between the boosting trolley and the tube fitting.

The tube fitting bending process monitoring module includes:
an anti-wrinkle die displacement sensor, embedded on an arc surface of the anti-wrinkle die, and positioned at a bottom of the arc surface, in which a contact position between the anti-wrinkle die and an innermost concave side of a straight tube section of the tube fitting; and a probe of the anti-wrinkle die displacement sensor is in contact with the tube fitting, an axis of the probe is perpendicular to an axis of the straight tube section of the tube fitting, and is configured to monitor the wrinkling situation in the bending process of the tube fitting, that is, measure a wrinkling corrugation displacement when the tube fitting is bent and wrinkled;
core ball end gyroscopes, mounted at link tails of the core balls and configured to monitor the state of the core balls in a bending process of the tube fitting and a rebound angle of the tube fitting when the tube fitting is bent and unloaded; and
a camera, mounted above the tube fitting through a camera bracket, and configured to real-time monitor a bending state of the tube fitting in a bending deformation process, including a cross-section distortion state. The camera adopts a depth camera, is mounted horizontally with a bending plane of the tube fitting, and can measure the deformation state of the exposed part of the tube fitting that is not in contact with the die when the tube fitting is bent.

All gyroscopes are high-accuracy six-axis gyroscopes, which can measure displacement, angle, velocity, angular velocity, acceleration and angular acceleration. All force sensors are multi-dimensional force sensors, which can measure pressure and friction. All temperature sensors are thermocouple temperature acquisition probes, which are only used during heating and bending, and can be chosen not to be used when bending at room temperature.
II. A method for real-time monitoring and prediction of the tube bending process state includes the following steps:
step 1) data acquisition: acquiring the state data of the tube bending device and the deformation data of the tube fitting in the bending process of the tube fitting in real time through multi-sensors of the data acquisition system;
data processing: preprocessing the data acquired by the data acquisition system through the data processing system, specifically including:
filtering and denoising the data acquired by the data acquisition system by the data filtering and denoising module, and unifying time stamps by the time series preprocessing module, and converting the time stamps into data with the same time stamp and the same time interval; and integrating the data processed by the time series preprocessing module to obtain the tube bending process comprehensive information model IM, and storing the data processed by the tube bending process comprehensive information model in a structured way through the historical information storage module; and
the present disclosure adopting a Kalman filter algorithm to filter the data and performs denoising processing to avoid adverse effects on the data caused by natural vibration of the tube bending device; and
step 3) prediction and visualization of state of the tube bending device and the tube fitting:
predicting the state information of the tube bending device and the bending state of the tube fitting at the current time and the future time according to the data preprocessed by the data processing system through the spatio-temporal fusion transformation module based on multi-task learning; and
visually presenting the die state of the tube bending device and the bending process of the tube fitting at present and in the future through unity by the twin model visual presentation module, and performing feedback control on the tube bending device to improve the forming quality.
In step 2):
the tube bending process comprehensive information model IM includes the total data Data_{Mach} of the tube bending device die state monitoring part and the total data Data_{Tube} of the tube fitting bending process monitoring part, and each data is time series data with equal time intervals; the tube bending process comprehensive information model IM includes the total data Data_{Mach} of the tube bending device die state monitoring part and the total data Data_{Tube} of the tube fitting bending process monitoring part, that is

IM={Data_{Mach},Data_{Tube}}
where the total data Data_{Mach} of the tube bending device die state monitoring part includes a bending die rotation angle θ_{bending}, a bending die bending speed ω_{bending}, a bending die angular acceleration α_{bending}, a bending die temperature T_{bending}, a pressure P_{clamping-tube} between the clamping die and the tube, a friction force F_{clamping-tube} between the clamping die and the tube, a pressing die displacement d_{pressing}, a pressing die speed v_{pressing}, a pressing die acceleration α_{pressing}, a pressure P_{pressing-tube} between the pressing die and the tube, a friction force F_{pressing-tube} between the pressing die and the tube, a temperature T_{pressing} of the pressing die, a boosting trolley displacement d_{boosting}, a boosting trolley speed v_{boosting}, a boosting trolley acceleration α_{boosting}, a pressure P_{boosting-tube} between the boosting trolley and the tube and a friction force F_{boosting-tube} between the boosting trolley and the tube, that is,

Data_{Mach}={θ_{bending},ω_{bending},α_{bending},T_{bending},P_{clamping-tube},F_{clamping-tube},d_{pressing},v_{pressing},α_{pressing},P_{pressing-tube},F_{pressing-tube},T_{pressing},d_{boosting},v_{boosting},α_{boosting},P_{boosting-tube} and F_{boosting-tube}}
the total data Data_{Tube} of the tube fitting bending process monitoring part includes a wrinkling corrugation displacement d_{wrinkling}, a tube bending angle θ_{tube} and tube fitting section deformation data ε_{tube}, that is,

Data_{Tube}={d_{wrinkling},θ_{tube},ε_{tube}}
all data in the tube bending process comprehensive information model IM are in the form of time series.
In step 3), the spatio-temporal fusion transformation module based on multi-task learning includes three parts: an input layer, a private-shared layer and a task output layer;
the input layer receives data of the tube bending process comprehensive information model IM, including the total data Data_{Mach} of the tube bending device die state monitoring part and the total data Data_{Tube} of the tube fitting bending process monitoring part;
the private-shared layer includes a shared long short-term memory (LSTM) module and two private LSTM modules, and the two private LSTM modules are an auxiliary task private LSTM module and a main task private LSTM module; the shared LSTM module receives two parts of data: the total data Data_{Mach} of the tube bending device die state monitoring part, and the total data Data_{Tube} of the tube fitting bending process monitoring part, which is used to extract common features and mine the interaction between the tube bending device and the tube fitting; and the auxiliary task private LSTM module and the main task private LSTM module respectively receive the total data Data_{Mach} of the tube bending device die state monitoring part, and the total data Data_{Tube} of the tube fitting bending process monitoring part, which is used to extract the time series evolution law of the tube bending device die state and the time series evolution law of the tube fitting bending process; and

the task output layer includes an auxiliary task Dense module, a feature fusion Concatenate module and a main task Dense module; output results of the auxiliary task private LSTM module and the shared LSTM module are added element by element and input to the auxiliary task Dense module, output results of the main task private LSTM module and the shared LSTM module are added element by element and input to the feature fusion Concatenate module together with output results of the auxiliary task Dense module for serial splicing to realize feature fusion, and the fused data is input to the main task Dense module; and the auxiliary task Dense module and the main task Dense module respectively output the prediction result of the tube bending device state and the prediction result of tube fitting bending forming as the final output results of the module.

The spatio-temporal fusion transformation module based on multi-task learning is trained by a joint loss function and adapted to multi-task learning scenarios, and the joint loss function is defined as a sum of a weight of a loss of auxiliary task of tube bending device die state L_{auxiliary} and a loss of main task of tube fitting bending process state Lₘₐᵢₙ:

$$L = {L}_{main} + α {L}_{auxiliary}$$

where L is a total loss of the model and the weight a is determined according to the empirical method.
In step 3):
the tube bending device die state and the tube fitting deformation state at the current time and the future time are predicted according to the tube bending device information and the tube bending state before the current time;
the tube bending device die state includes an abnormal tube bending device state, including vibration of the tube bending device; and
the predicting the tube fitting deformation state includes predicting a distortion defect of a tube fitting section.

The tube bending device can be compensated online according to the wrinkling corrugation directly measured by the sensor and the cross-section distortion defect obtained by prediction, and the compensation can be realized by speeding up or slowing down the speed of the bending die, the pressing die and the boosting trolley and increasing or decreasing the pressure of the pressing die and the boosting trolley on the tube fitting; and
the tube bending device can be bent again online according to a rebound angle of the tube fitting measured after bending and unloading.

Advantageous effects of the present disclosure are as follows.

In the present disclosure, the corresponding sensor is arranged at a suitable position in the tube bending device and the tube bending site to carry out time series acquisition of the running state of the tube bending device and the deformation state of the tube fitting, and the digital twin data model of the tube bending process is obtained by data processing system, and the integration of the state data of the tube bending device and the tube fitting in the tube bending process is realized. The integrated time series information is modeled by the spatio-temporal fusion transformation module based on multi-task learning, and the interaction between the tube bending device and the tube fitting state in the bending process is comprehensively considered through multi-task learning, and the influence of the future state of the tube bending device information on the future state of tube fitting forming can be considered to achieve more accurate prediction of the tube forming state. By using the data before the current moment to predict the state of the tube bending device and tube fittings at the current moment, the time lag caused by the data processing process is compensated, the real-time performance of the digital twin model is improved, and the future state can be predicted at the same time, which provides a basis for the digital twin system to optimize the bending process in real time through decision-making. The real-time monitoring state and future prediction results are finally visualized through the twin model, which effectively realizes the multi-directional online real-time monitoring and future prediction of the mold state of tube bending device and the bending process of tube fittings, which can improve the intelligent level of the bending process of tube fittings and improve the quality of bending and forming of tube fittings.

### BRIEF DESCRIPTION OF THE DRAWINGS

FIG. 1 is a schematic diagram of a tube bending process according to the present disclosure;

FIG. 2 is a simplified schematic diagram of a tube bending device according to the present disclosure;

FIG. 3 is a simplified schematic diagram of an overall structure of a system according to the present disclosure;

FIG. 4 is a cross-sectional view of the overall structure of the system according to the present disclosure;

FIG. 5 is a schematic mounting diagram of an anti-wrinkle die displacement sensor according to the present disclosure;

FIG. 6 is a structural diagram of an anti-wrinkle die according to the present disclosure;

FIG. 7 is a schematic diagram of the system according to the present disclosure; and

FIG. 8 is a schematic diagram of a spatio-temporal fusion transformation module based on multi-task learning.

Reference numerals and denotations thereof: 1—tube bending device; 2—tube fitting; 3—data acquisition system; 4—data processing system; 5—twin model system; 6—bending die; 7—insert block; 8—clamping die; 9—pressing die; 10—anti-wrinkle die; 11—boosting trolley; 12—core shaft; 13—core ball; 14—bending die gyroscope; 15—bending die temperature sensor; 16—clamping die force sensor; 17—clamping die temperature sensor; 18—pressing die gyroscope; 19—pressing die force sensor; 20—pressing die temperature sensor; 21—boosting trolley gyroscope; 22—boosting trolley force sensor; 23—anti-wrinkle die displacement sensor; 24—core ball end gyroscope; 25—camera bracket; 26—camera; 41—data filtering and denoising module; 42—time series preprocessing module; 43—tube bending process comprehensive information model; 44—historical information storage module; 51—spatio-temporal fusion transformation module based on multi-task learning; and 52—twin model visual presentation module.

### DETAILED DESCRIPTION

The present disclosure will be described in further detail below with reference to the accompanying drawings and specific examples.

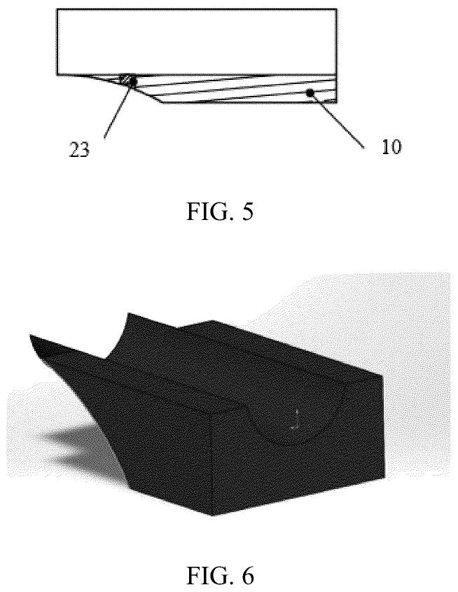

As shown in FIGS. 1-7, the present disclosure includes a tube bending device 1, a tube fitting 2, a data acquisition system 3, a data processing system 4 and a twin model system 5.

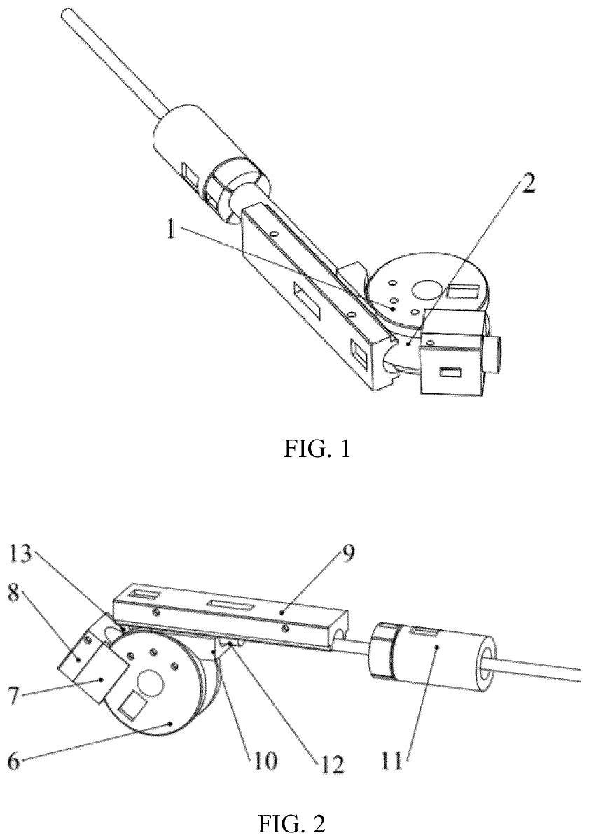

As shown in FIG. 2, the tube bending device 1 includes a bending die 6, an insert block 7, a clamping die 8, a pressing die 9, an anti-wrinkle die 11 and a boosting trolley 11, a core shaft 12 and core balls 13.

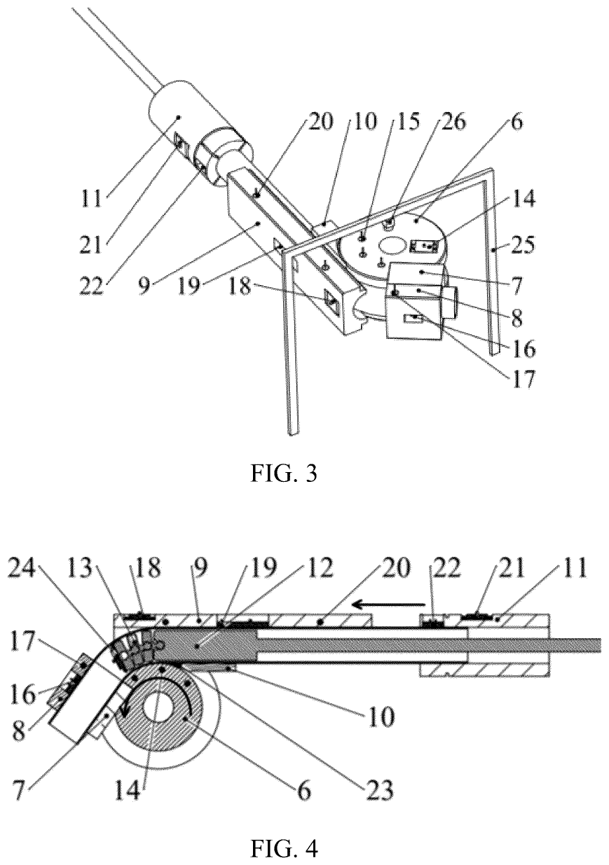

As shown in FIGS. 3-4, the data acquisition system 3 includes a tube bending device die state monitoring part and a tube fitting bending process monitoring part, the tube bending device die state monitoring part includes a bending die gyroscope 14, bending die temperature sensors 15, a clamping die force sensor 16, a clamping die temperature sensor 17, a pressing die gyroscope 18, a pressing die force sensor 19, pressing die temperature sensors 20, a boosting trolley gyroscope 21 and a boosting trolley force sensor 22; and the tube fitting bending process monitoring part includes an anti-wrinkle die displacement sensor 23, core ball end gyroscopes 24, a camera bracket 25 and a camera 26. All gyroscopes are high-accuracy six-axis gyroscopes, which can measure displacement, angle, velocity, angular velocity, acceleration and angular acceleration. All force sensors are multi-dimensional force sensors. The temperature sensors are thermocouple temperature acquisition probes, which are only used during heating and bending, and can be chosen not to be used when bending at room temperature.

As shown in FIGS. 3-4, in the tube bending device die state monitoring part, the bending die gyroscope 14 is embedded on an upper surface of the bending die 6 to accurately measure a rotation angle, bending speed and angular acceleration of the bending die 6, and a plurality of the bending die temperature sensors 15 are embedded on the bending die 6 to penetrate through upper and lower surfaces of the bending die 6 to ensure that the temperature of a contact part between the bending die 6 and the tube fitting 2 is measured. The clamping die force sensor 16 is embedded on the contact surface with the tube fitting 2, the contact part of the clamping die force sensor 16 with the tube fitting 2 has an arc surface, and a contact surface of the clamping die 8 with the tube fitting 2 has a common arc surface; and the clamping die force sensor 16 is at least a two-dimensional force sensor, one dimension measures the pressure between the clamping die 8 and the tube fitting 2, and the other dimension measures the friction force between the clamping die 8 and the tube fitting 2. Because the clamping die 8 rotates synchronously with the bending die 6, there is no gyroscope in the clamping die 8. The pressing die gyroscope 18 is embedded on an outer surface of the pressing die 9, and can accurately measure a feed displacement, speed and acceleration of the pressing die 9. The pressing die force sensor 19 is embedded on a contact surface with the tube fitting 2, the contact part of the pressing die force sensor 19 and the tube fitting 2 has an arc surface, and the contact surface of the pressing die 9 and the tube fitting 2 has a common arc surface; and the pressing die force sensor 19 is at least a two-dimensional force sensor, one dimension measures the pressure between the pressing die 9 and the tube fitting 2, and the other dimension measures the friction force between the pressing die 8 and the tube fitting 2. A plurality of the pressing die temperature sensors 20 are uniformly embedded on the pressing die 9, penetrate through upper and lower surfaces of the pressing die 9, and ensure that the temperature of the contact part between the pressing die 9 and the tube fitting 2 is measured. The boosting trolley gyroscope 21 is embedded on an outer surface of the boosting trolley 11, and can accurately measure a feed displacement, speed and acceleration of the boosting trolley 11. The boosting trolley force sensor 22 is embedded on a contact surface with the tube fitting 2, the contact part of the boosting trolley force sensor 22 and the tube fitting 2 has an arc surface, and a contact surface of the boosting trolley 11 and the tube fitting 2 has a common arc surface; and the boosting trolley force sensor 22 is at least a two-dimensional force sensor, one dimension measures the pressure between the boosting trolley 11 and the tube fitting 2, and the other dimension measures the friction force between the boosting trolley 11 and the tube fitting 2.

As shown in FIGS. 3-6, in the tube fitting bending process monitoring part, a bottom of a curved surface of the anti-wrinkle die 10 (that is, a contact position with the innermost concave side of the straight tube section of the tube fitting) is opened and embedded to mounted the anti-wrinkle die displacement sensor 23, a probe of the anti-wrinkle die displacement sensor 23 is probed out and contacted with the tube fitting 2. When the tube fitting 2 is bent and wrinkled, the wrinkle ripple displacement can be measured, which is used to monitor the wrinkling situation in the bending process of the tube fitting. The core ball end gyroscopes 24 are mounted at link tails of the core balls 13, and can monitor the state of the core balls 13 in the bending process of the tube fitting. When the tube fitting 2 is bent and unloaded at the end, the rebound angle of the tube fitting 2 can be measured, and the tube bending device 1 can be bent and compensated again online according to the measured rebound angle. The camera 26 is mounted at the camera bracket 25, and the camera 26 adopts a depth camera and is mounted in parallel with a bending plane of the tube fitting 2, the deformation state of the part of the tube fitting 2 that is exposed outside without contact with the mold when the tube fitting 2 is bent can be measured, and the cross-sectional deformation data in the bending deformation process of the tube fitting 2 is monitored in real time to observe the distortion state.

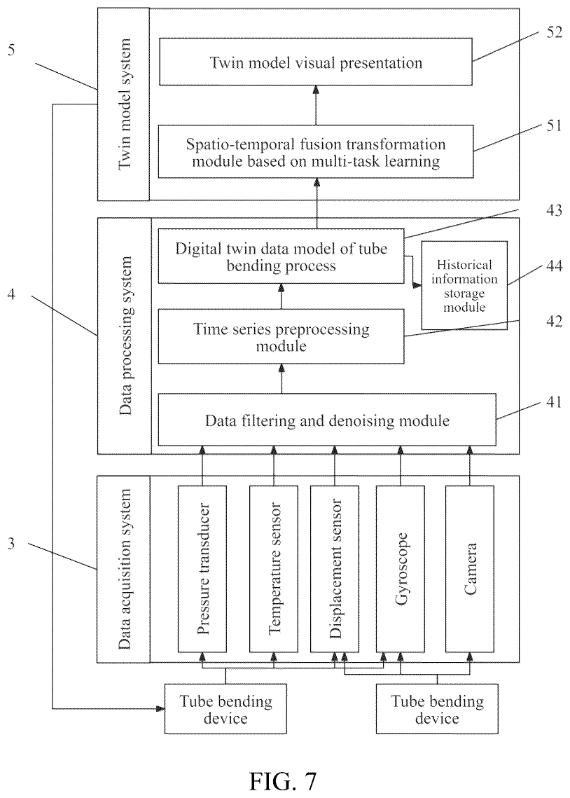

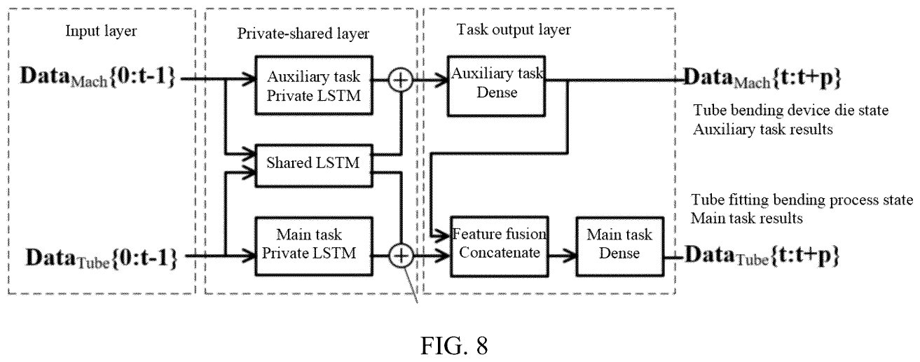

As shown in FIG. 7, the digital twin model system of the tube bending device includes the tube bending device 1, the tube fitting 2, the data acquisition system 3, the data processing system 4 and the twin model system 5. The data processing system 4 includes a data filtering and denoising module 41, a time series preprocessing module 42, a tube bending process comprehensive information model 43 and a historical information storage module 44. The data filtering and denoising module 41 filters and denoises the data acquired by multiple sensors in the data acquisition system 3 respectively. In the present disclosure, a Kalman filter algorithm is adopted to filter the data, and carries out denoising processing to avoid the adverse effects of the natural vibration of the tube bending device 1 and the like on the data, and the time stamps are unified by the time series preprocessing module 42 and converted into data with the same time stamp and the same time interval. The tube bending process comprehensive information model IM 43 includes the total data Data_{Mach} of the tube bending device die state monitoring part and the total data Data_{Tube} of the tube fitting bending process monitoring part, and each data is time series data with equal time intervals. The tube bending process comprehensive information model IM 43 includes the total data Data_{Mach} of the tube bending device die state monitoring part and the total data Data_{Tube} of the tube fitting bending process monitoring part, that is,

IM={Data_{Mach},Data_{Tube}}
where the total data Data_{Mach} of the tube bending device die state monitoring part includes a bending die rotation angle θ_{bending}, a bending die bending speed ω_{bending}, a bending die angular acceleration α_{bending}, a bending die temperature T_{bending}, a pressure P_{clamping-tube} between the clamping die and the tube, a friction force F_{clamping-tube} between the clamping die and the tube, a pressing die displacement d_{pressing}, a pressing die speed v_{pressing}, a pressing die acceleration α_{pressing}, a pressure P_{pressing-tube} between the pressing die and the tube, a friction force F_{pressing-tube} between the pressing die and the tube, a temperature T_{pressing} of the pressing die, a boosting trolley displacement d_{boosting}, a boosting trolley speed v_{boosting}, a boosting trolley acceleration α_{boosting}, a pressure P_{boosting-tube} between the boosting trolley and the tube and a friction force F_{boosting-tube} between the boosting trolley and the tube, that is,

Data_{Mach}={θ_{bending},ω_{bending},α_{bending},T_{bending},P_{clamping-tube},F_{clamping-tube},d_{pressing},v_{pressing},α_{pressing},P_{pressing-tube},F_{pressing-tube},T_{pressing},d_{boosting},v_{boosting},α_{boosting},P_{boosting-tube} and F_{boosting-tube}}

The total data Data_{Tube} of the tube fitting bending process monitoring part includes a wrinkling corrugation displacement d_{wrinkling}, a tube bending angle θ_{tube} and tube fitting section deformation data ε_{tube}, that is,

Data_{Tube}={d_{wrinkling},θ_{tube},ε_{tube}}

All data in the tube bending process comprehensive information model IM 43 are performed in a time series form, and finally, the historical information storage module 44 structurally stores the data processed by the tube bending process comprehensive information model 43. The twin model system 5 includes a spatio-temporal fusion transformation module based on multi-task learning 51 and a twin model visual presentation module 52. The spatio-temporal fusion transformation module based on multi-task learning 51 is based on a private-shared multi-task learning framework, which is used to receive the tube bending process comprehensive information model IM 43 and perform the time series prediction of the tube bending device die state and the tube fitting bending process, thereby realizing the prediction of the tube bending device die state and the tube bending process at current and future state (including defect monitoring and prediction of cross-section distortion), and finally, the twin model visual presentation module 52 visualizes the tube bending device die state and the tube fitting bending process through Unity, and carries out feedback control on the tube bending device 1 to improve the forming quality.

As shown in FIG. 7, the spatio-temporal fusion transformation module based on multi-task learning 51 is based on a private-shared multi-task learning framework, and the framework includes two sub-tasks, an auxiliary task of the tube bending device die state and a main task of the tube bending process state. The main task of the tube bending process state is used to predict the forming quality of tube fittings, and the auxiliary task of tube bending device die state is used to predict the state of tube bending device (including predicting whether the tube bending machine is abnormal: such as vibration and temperature abnormality). Because the tube bending device die state will affect the forming quality of tube fittings, output results of an auxiliary task of a task output layer are integrated into the main task prediction to improve the robustness and accuracy of the main task of the tube fitting bending process state.

The private-shared multi-task learning framework includes three parts: an input layer, a private-shared layer and a task output layer. The input layer receives the tube bending process comprehensive information model IM 43, which is divided into two parts: the total data Data_{Mach} of the tube bending device die state monitoring part and the total data Data_{Tube} of the tube fitting bending process monitoring part. The private-shared layer includes a shared LSTM module and two private LSTM modules, and the two private LSTM modules are an auxiliary task private LSTM module and a main task private LSTM module. The shared LSTM module receives two parts of data: the total data Data_{Mach} of the tube bending device die state monitoring part, and the total data Data_{Tube} of the tube fitting bending process monitoring part, which is used to extract common features and mine the interaction between the tube bending device and the tube fitting. The two private LSTM modules respectively receive the total data Data_{Mach} of the tube bending device die state monitoring part, and the total data Data_{Tube} of the tube fitting bending process monitoring part, which is used to extract the time series evolution law of the tube bending device die state and the time series evolution law of the tube fitting bending process. The output results of the shared LSTM are added element by element with the output results of the private LSTM of the main task and the auxiliary task. The output layer includes an auxiliary task Dense module, a feature fusion Concatenate module and a main task Dense module. The Dense module only receives the information of the auxiliary task of the mold state of the tube bending device after the private-shared layer processing. The auxiliary task Dense module processes the input data to obtain the final auxiliary task prediction result. The feature fusion Concatenate module receives the main task information of the bending process state of the tube fitting processed by the private-shared layer and the output results of the auxiliary task of the tube bending device die state, performs series splicing operations to realize the feature fusion, and finally generates the future prediction results of the main task through the main task Dense module. Finally, the model is trained by a joint loss function and adapted to the multi-task learning scenarios, and the joint loss function is defined as a sum of a weight of a loss of auxiliary task of tube bending device die state L_{auxiliary} and a loss of main task of tube fitting bending process state Lₘₐᵢₙ:

$$L = {L}_{main} + α {L}_{auxiliary}$$

where L is a total loss of the model, and the weight a is determined according to the empirical method.

Through online training, the tube bending device information (including abnormal running state such as device vibration) and the tube bending state (including predicting defects such as cross-section distortion) at the current time t and the future time can be predicted by the tube bending device information and the tube forming state before the current time of tube bending, and the influence of the future state of the tube bending device information on the future state of tube forming can be comprehensively considered to realize the prediction of the tube forming state and make the prediction more accurate.

1. A digital twin system for real-time monitoring and prediction of a tube bending process state, comprising a tube bending device (1), a tube fitting (2), a data acquisition system (3), a data processing system (4) and a twin model system (5), wherein the data acquisition system (3) is configured to acquire the state data of each die of the tube bending device (1) and the deformation data of the tube fitting in a bending process of the tube fitting (2); the data processing system (4) is configured to preprocess the data acquired by the data acquisition system (3); and the twin model system (5) predicts the die state of the tube bending device (1) and the bending state of the tube fitting (2) at the current time and the future time according to the data preprocessed by the data processing system (4).

2. The digital twin system for real-time monitoring and prediction of a tube bending process state according to claim 1, wherein,
the tube bending device (1) comprises a bending die (6), an insert block (7), a clamping die (8), a pressing die (9), an anti-wrinkle die (10) and a boosting trolley (11), a core shaft (12) and core balls (13); a tail part of the tube fitting (2) is clamped by a chuck of a boosting trolley (11), the other end of the tube fitting (2) is clamped by the insert block (7) and the clamping die (8), and a middle part is clamped by the pressing die (9) and the anti-wrinkle die (10); the core balls (13) and the core shaft (12) for supporting a tube wall are arranged in the tube fitting (2), a plurality of core balls (13) are connected in series and hinged on the core shaft (12), and the bending die (6) are fixedly connected to the insert block (7); the bending die (6), the insert block (7) and the clamping die (8) rotate synchronously, torque is applied to the tube fitting (2) through the synergistic effect of pressure and friction, and with the increase of rotation angle, the tube fitting (2) is plastically deformed; in a bending process, the anti-wrinkle die (10) and the core shaft (12) remain stationary, and the plurality of core balls (13) oscillate with the change of an axial shape of the tube fitting (2); and in the bending process, the pressing die (9) and the boosting trolley (11) move forward to provide forward power for an unbent part of the tube fitting (2) through pressure and friction;
the data acquisition system (3) comprises a tube bending device die state monitoring module and a tube fitting bending process monitoring module; the state data of each die of the tube bending device (1) is acquired by the tube bending device die state monitoring module, and the deformation data of the tube fitting (2) in the bending process of the tube fitting (2) is acquired by the tube fitting bending process monitoring module;
the data processing system (4) comprises a data filtering and denoising module (41), a time series preprocessing module (42), a tube bending process comprehensive information model (43), and a historical information storage module (44); and
the twin model system (5) comprises a spatio-temporal fusion transformation module based on multi-task learning (51) and a twin model visual presentation module (52).

3. A multi-sensor data acquisition and state monitoring system for digital twin of the tube bending process according to claim 2, wherein the tube bending device die state monitoring module comprises:
a bending die gyroscope (14), embedded on a surface of the bending die (6), and configured to measure a rotation angle, bending speed and angular acceleration of the bending die (6);
a plurality of bending die temperature sensors (15), evenly distributed on the bending die (6) and penetrating through the bending die (6) up and down, and configured to measure a temperature of the bending die (6);
a clamping die force sensor (16), with a curved sensor induction surface, wherein the sensor (16) is embedded on an inner surface of the clamping die (8), that is, a contact surface with the tube fitting (2), and the sensor induction surface are completely fitted with the tube fitting (2); and the clamping die force sensor (16) is configured to measure acting forces between the clamping die (8) and the tube fitting (2), comprising a pressure between the clamping die (8) and the tube fitting (2) and a friction force between the clamping die (8) and the tube fitting (2);
a pressing die gyroscope (18), embedded on a surface of the pressing die (9), and configured to measure a feed displacement, speed and acceleration of the pressing die (9);
a pressing die force sensor (19), with a curved sensor induction surface, wherein the sensor (19) is embedded on an inner surface of the pressing die (9), that is, a contact surface with the tube fitting, and the sensor sensing surface are completely fitted with the tube fitting (2); and the pressing die force sensor (19) is configured to measure acting forces between the pressing die (9) and the tube fitting (2), comprising a pressure between the pressing die (9) and the tube fitting (2) and a friction force between the pressing die (9) and the tube fitting (2);
a plurality of pressing die temperature sensors (20), uniformly distributed on the pressing die (9) and penetrating through the pressing die (9) up and down, and configured to measure the temperature of the pressing die (9);
a boosting trolley gyroscope (21), embedded on an outer surface of the boosting trolley (11) and configured to measure a feed displacement, speed and acceleration of the boosting trolley (11); and
a boosting trolley force sensor (22), with a curved sensor induction surface, wherein the sensor (22) embedded on an inner surface of a chuck of the boosting trolley (11), that is, a contact surface with the tube fitting (2), and the sensor induction surface are completely fitted with the tube fitting (2); and the boosting trolley force sensor (22) is configured to measure acting forces between the boosting trolley (11) and the tube fitting, comprising a pressure between the boosting trolley (11) and the tube fitting (2) and a friction force between the boosting trolley (11) and the tube fitting (2).

4. The multi-sensor data acquisition and state monitoring system for digital twin of the tube bending process according to claim 2, wherein the tube bending process monitoring module comprises:
an anti-wrinkle die displacement sensor (23), embedded on an arc surface of the anti-wrinkle die (10), and positioned at a bottom of the arc surface, wherein, a contact position between the anti-wrinkle die (10) and an innermost concave side of a straight tube section of the tube fitting (2); and a probe of the anti-wrinkle die displacement sensor (23) is in contact with the tube fitting (2), an axis of the probe is perpendicular to an axis of the straight tube section of the tube fitting (2), and is configured to measure a wrinkling corrugation displacement when the tube fitting (2) is bent and wrinkled;
core ball end gyroscopes (24), mounted at link tails of the core balls (13) and configured to monitor the state of the core balls (13) in a bending process of the tube fitting (2) and a rebound angle of the tube fitting (2) when the tube fitting (2) is bent and unloaded; and
a camera (26), mounted above the tube fitting (2) through a camera bracket (25), and configured to real-time monitor a bending state of the tube fitting (2) in a bending deformation process, comprising a cross-section distortion state.

5. A real-time monitoring and prediction method by adopting the system according to claim 1, comprising the following steps:
step 1) data acquisition: acquiring the state data of the tube bending device (1) and the deformation data of the tube fitting (2) in the bending process of the tube fitting (2) in real time through multi-sensors of the data acquisition system (3);
step 2) data processing: preprocessing the data acquired by the data acquisition system (3) through the data processing system (4), specifically comprising:
filtering and denoising the data acquired by the data acquisition system (3) by the data filtering and denoising module (41), and unifying time stamps by the time series preprocessing module (42), and converting the time stamps into data with the same time stamp and the same time interval; and integrating the data processed by the time series preprocessing module (42) to obtain the tube bending process comprehensive information model IM (43), and storing the data processed by the tube bending process comprehensive information model (43) in a structured way through the historical information storage module (44); and
step 3) prediction and visualization of states of the tube bending device (1) and the tube fitting (2):
predicting the state information of the tube bending device (1) and the bending state of the tube fitting (2) at the current time and the future time according to the data preprocessed by the data processing system (4) through the spatio-temporal fusion transformation module based on multi-task learning (51); and
visually presenting the die state of the tube bending device (1) and the bending process of the tube fitting (2) at present and in the future through unity by the twin model visual presentation module (52), and performing feedback control on the tube bending device (1).

6. A real-time monitoring and prediction method by adopting the system according to claim 2, comprising the following steps:
step 1) data acquisition: acquiring the state data of the tube bending device (1) and the deformation data of the tube fitting (2) in the bending process of the tube fitting (2) in real time through multi-sensors of the data acquisition system (3);
step 2) data processing: preprocessing the data acquired by the data acquisition system (3) through the data processing system (4), specifically comprising:
filtering and denoising the data acquired by the data acquisition system (3) by the data filtering and denoising module (41), and unifying time stamps by the time series preprocessing module (42), and converting the time stamps into data with the same time stamp and the same time interval; and integrating the data processed by the time series preprocessing module (42) to obtain the tube bending process comprehensive information model IM (43), and storing the data processed by the tube bending process comprehensive information model (43) in a structured way through the historical information storage module (44); and
step 3) prediction and visualization of states of the tube bending device (1) and the tube fitting (2):
predicting the state information of the tube bending device (1) and the bending state of the tube fitting (2) at the current time and the future time according to the data preprocessed by the data processing system (4) through the spatio-temporal fusion transformation module based on multi-task learning (51); and
visually presenting the die state of the tube bending device (1) and the bending process of the tube fitting (2) at present and in the future through unity by the twin model visual presentation module (52), and performing feedback control on the tube bending device (1).

7. A real-time monitoring and prediction method by adopting the system according to claim 3, comprising the following steps:
step 1) data acquisition: acquiring the state data of the tube bending device (1) and the deformation data of the tube fitting (2) in the bending process of the tube fitting (2) in real time through multi-sensors of the data acquisition system (3);
step 2) data processing: preprocessing the data acquired by the data acquisition system (3) through the data processing system (4), specifically comprising:
filtering and denoising the data acquired by the data acquisition system (3) by the data filtering and denoising module (41), and unifying time stamps by the time series preprocessing module (42), and converting the time stamps into data with the same time stamp and the same time interval; and integrating the data processed by the time series preprocessing module (42) to obtain the tube bending process comprehensive information model IM (43), and storing the data processed by the tube bending process comprehensive information model (43) in a structured way through the historical information storage module (44); and
step 3) prediction and visualization of states of the tube bending device (1) and the tube fitting (2):
predicting the state information of the tube bending device (1) and the bending state of the tube fitting (2) at the current time and the future time according to the data preprocessed by the data processing system (4) through the spatio-temporal fusion transformation module based on multi-task learning (51); and
visually presenting the die state of the tube bending device (1) and the bending process of the tube fitting (2) at present and in the future through unity by the twin model visual presentation module (52), and performing feedback control on the tube bending device (1).

8. A real-time monitoring and prediction method by adopting the system according to claim 4, comprising the following steps:
step 1) data acquisition: acquiring the state data of the tube bending device (1) and the deformation data of the tube fitting (2) in the bending process of the tube fitting (2) in real time through multi-sensors of the data acquisition system (3);
step 2) data processing: preprocessing the data acquired by the data acquisition system (3) through the data processing system (4), specifically comprising:
filtering and denoising the data acquired by the data acquisition system (3) by the data filtering and denoising module (41), and unifying time stamps by the time series preprocessing module (42), and converting the time stamps into data with the same time stamp and the same time interval; and integrating the data processed by the time series preprocessing module (42) to obtain the tube bending process comprehensive information model IM (43), and storing the data processed by the tube bending process comprehensive information model (43) in a structured way through the historical information storage module (44); and
step 3) prediction and visualization of states of the tube bending device (1) and the tube fitting (2):
predicting the state information of the tube bending device (1) and the bending state of the tube fitting (2) at the current time and the future time according to the data preprocessed by the data processing system (4) through the spatio-temporal fusion transformation module based on multi-task learning (51); and
visually presenting the die state of the tube bending device (1) and the bending process of the tube fitting (2) at present and in the future through unity by the twin model visual presentation module (52), and performing feedback control on the tube bending device (1).

9. The real-time monitoring and prediction method according to claim 5, wherein in step 2):
the tube bending process comprehensive information model IM (43) comprises the total data Data_{Mach} of the tube bending device die state monitoring part and the total data Data_{Tube} of the tube fitting bending process monitoring part, and each data is time series data with equal time intervals;
and the tube bending process comprehensive information model IM (43) comprises the total data Data_{Mach} of the tube bending device die state monitoring part and the total data Data_{Tube} of the tube fitting bending process monitoring part, that is
IM={Data_{Mach},Data_{Tube}}
where the total data Data_{Mach} of the tube bending device die state monitoring part comprises a bending die rotation angle θ_{bending}, a bending die bending speed ω_{bending}, a bending die angular acceleration α_{bending}, a bending die temperature T_{bending}, a pressure P_{clamping-tube} between the clamping die and the tube, a friction force F_{clamping-tube} between the clamping die and the tube, a pressing die displacement d_{pressing}, a pressing die speed v_{pressing}, a pressing die acceleration α_{pressing}, a pressure P_{pressing-tube} between the pressing die and the tube, a friction force F_{pressing-tube} between the pressing die and the tube, a temperature T_{pressing} of the pressing die, a boosting trolley displacement d_{boosting}, a boosting trolley speed v_{boosting}, a boosting trolley acceleration α_{boosting}, a pressure P_{boosting-tube} between the boosting trolley and the tube, and a friction force F_{boosting-tube} between the boosting trolley and the tube, that is,
Data_{Mach}={θ_{bending},ω_{bending},α_{bending},T_{bending},P_{clamping-tube},F_{clamping-tube},d_{pressing},v_{pressing},α_{pressing},P_{pressing-tube},F_{pressing-tube},T_{pressing},d_{boosting},v_{boosting},α_{boosting},P_{boosting-tube} and F_{boosting-tube}}
the total data Data_{Tube} of the tube fitting bending process monitoring part comprises a wrinkling corrugation displacement d_{wrinkling}, a tube bending angle θ_{tube} and tube fitting section deformation data ε_{tube}, that is,
Data_{Tube}={d_{wrinkling},θ_{tube},ε_{tube}}
all data in the tube bending process comprehensive information model IM are in the form of time series.

10. The real-time monitoring and prediction method according to claim 6, wherein in step 2):
the tube bending process comprehensive information model IM (43) comprises the total data Data_{Mach} of the tube bending device die state monitoring part and the total data Data_{Tube} of the tube fitting bending process monitoring part, and each data is time series data with equal time intervals; and the tube bending process comprehensive information model IM (43) comprises the total data Data_{Mach} of the tube bending device die state monitoring part and the total data Data_{Tube} of the tube fitting bending process monitoring part, that is
IM={Data_{Mach},Data_{Tube}}
where the total data Data_{Mach} of the tube bending device die state monitoring part comprises a bending die rotation angle θ_{bending}, a bending die bending speed ω_{bending}, a bending die angular acceleration α_{bending}, a bending die temperature T_{bending}, a pressure P_{clamping-tube} between the clamping die and the tube, a friction force F_{clamping-tube} between the clamping die and the tube, a pressing die displacement d_{pressing}, a pressing die speed v_{pressing}, a pressing die acceleration α_{pressing}, a pressure P_{pressing-tube} between the pressing die and the tube, a friction force F_{pressing-tube} between the pressing die and the tube, a temperature T_{pressing} of the pressing die, a boosting trolley displacement d_{boosting}, a boosting trolley speed v_{boosting}, a boosting trolley acceleration α_{boosting}, a pressure P_{boosting-tube} between the boosting trolley and the tube, and a friction force F_{boosting-tube} between the boosting trolley and the tube, that is,
Data_{Mach}={θ_{bending},ω_{bending},α_{bending},T_{bending},P_{clamping-tube},F_{clamping-tube},d_{pressing},v_{pressing},α_{pressing},P_{pressing-tube},F_{pressing-tube},T_{pressing},d_{boosting},v_{boosting},α_{boosting},P_{boosting-tube} and F_{boosting-tube}}
the total data Data_{Tube} of the tube fitting bending process monitoring part comprises a wrinkling corrugation displacement d_{wrinkling}, a tube bending angle θ_{tube} and tube fitting section deformation data ε_{tube}, that is,
Data_{Tube}={d_{wrinkling},θ_{tube},ε_{tube}}
all data in the tube bending process comprehensive information model IM are in the form of time series.

11. The real-time monitoring and prediction method according to claim 7, wherein in step 2):
the tube bending process comprehensive information model IM (43) comprises the total data Data_{Mach} of the tube bending device die state monitoring part and the total data Data_{Tube} of the tube fitting bending process monitoring part, and each data is time series data with equal time intervals; and the tube bending process comprehensive information model IM (43) comprises the total data Data_{Mach} of the tube bending device die state monitoring part and the total data Data_{Tube} of the tube fitting bending process monitoring part, that is
IM={Data_{Mach},Data_{Tube}}
where the total data Data_{Mach} of the tube bending device die state monitoring part comprises a bending die rotation angle θ_{bending}, a bending die bending speed ω_{bending}, a bending die angular acceleration α_{bending}, a bending die temperature T_{bending}, a pressure P_{clamping-tube} between the clamping die and the tube, a friction force F_{clamping-tube} between the clamping die and the tube, a pressing die displacement d_{pressing}, a pressing die speed v_{pressing}, a pressing die acceleration α_{pressing}, a pressure P_{pressing-tube} between the pressing die and the tube, a friction force F_{pressing-tube} between the pressing die and the tube, a temperature T_{pressing} of the pressing die, a boosting trolley displacement d_{boosting}, a boosting trolley speed v_{boosting}, a boosting trolley acceleration α_{boosting}, a pressure P_{boosting-tube} between the boosting trolley and the tube, and a friction force F_{boosting-tube} between the boosting trolley and the tube, that is,
Data_{Mach}={θ_{bending},ω_{bending},α_{bending},T_{bending},P_{clamping-tube},F_{clamping-tube},d_{pressing},v_{pressing},α_{pressing},P_{pressing-tube},F_{pressing-tube},T_{pressing},d_{boosting},v_{boosting},α_{boosting},P_{boosting-tube} and F_{boosting-tube}}
the total data Data_{Tube} of the tube fitting bending process monitoring part comprises a wrinkling corrugation displacement d_{wrinkling}, a tube bending angle θ_{tube} and tube fitting section deformation data ε_{tube}, that is,
Data_{Tube}={d_{wrinkling},θ_{tube},ε_{tube}}
all data in the tube bending process comprehensive information model IM are in the form of time series.

12. The real-time monitoring and prediction method according to claim 8, wherein in step 2):
the tube bending process comprehensive information model IM (43) comprises the total data Data_{Mach} of the tube bending device die state monitoring part and the total data Data_{Tube} of the tube fitting bending process monitoring part, and each data is time series data with equal time intervals; and the tube bending process comprehensive information model IM (43) comprises the total data Data_{Mach} of the tube bending device die state monitoring part and the total data Data_{Tube} of the tube fitting bending process monitoring part, that is
IM={Data_{Mach},Data_{Tube}}
where the total data Data_{Mach} of the tube bending device die state monitoring part comprises a bending die rotation angle θ_{bending}, a bending die bending speed ω_{bending}, a bending die angular acceleration α_{bending}, a bending die temperature T_{bending}, a pressure P_{clamping-tube} between the clamping die and the tube, a friction force F_{clamping-tube} between the clamping die and the tube, a pressing die displacement d_{pressing}, a pressing die speed v_{pressing}, a pressing die acceleration α_{pressing}, a pressure P_{pressing-tube} between the pressing die and the tube, a friction force F_{pressing-tube} between the pressing die and the tube, a temperature T_{pressing} of the pressing die, a boosting trolley displacement d_{boosting}, a boosting trolley speed v_{boosting}, a boosting trolley acceleration α_{boosting}, a pressure P_{boosting-tube} between the boosting trolley and the tube, and a friction force F_{boosting-tube} between the boosting trolley and the tube, that is,
Data_{Mach}={θ_{bending},ω_{bending},α_{bending},T_{bending},P_{clamping-tube},F_{clamping-tube},d_{pressing},v_{pressing},α_{pressing},P_{pressing-tube},F_{pressing-tube},T_{pressing},d_{boosting},v_{boosting},α_{boosting},P_{boosting-tube} and F_{boosting-tube}}
the total data Data_{Tube} of the tube fitting bending process monitoring part comprises a wrinkling corrugation displacement d_{wrinkling}, a tube bending angle θ_{tube} and tube fitting section deformation data ε_{tube}, that is,
Data_{Tube}={d_{wrinkling},θ_{tube},ε_{tube}}
all data in the tube bending process comprehensive information model IM are in the form of time series.

13. The real-time monitoring and prediction method according to claim 5, wherein in step 3), the spatio-temporal fusion transformation module based on multi-task learning (51) comprises three parts: an input layer, a private-shared layer and a task output layer;
the input layer receives data of the tube bending process comprehensive information model IM (43), comprising the total data Data_{Mach} of the tube bending device die state monitoring part and the total data Data_{Tube} of the tube fitting bending process monitoring part;
the private-shared layer comprises a shared long short-term memory (LSTM) module and two private LSTM modules, and the two private LSTM modules are an auxiliary task private LSTM module and a main task private LSTM module; the shared LSTM module receives two parts of data: the total data Data_{Mach} of the tube bending device die state monitoring part, and the total data Data_{Tube} of the tube fitting bending process monitoring part; and the auxiliary task private LSTM module and the main task private LSTM module respectively receive the total data Data_{Mach} of the tube bending device die state monitoring part, and the total data Data_{Tube} of the tube fitting bending process monitoring part; and
the task output layer comprises an auxiliary task Dense module, a feature fusion Concatenate module and a main task Dense module; output results of the auxiliary task private LSTM module and the shared LSTM module are added element by element and input to the auxiliary task Dense module, output results of the main task private LSTM module and the shared LSTM module are added element by element and input to the feature fusion Concatenate module together with output results of the auxiliary task Dense module for serial splicing to realize feature fusion, and the fused data is input to the main task Dense module; and the auxiliary task Dense module and the main task Dense module respectively output the prediction result of the tube bending device state and the prediction result of tube fitting bending forming as the final output results of the module.

14. The real-time monitoring and prediction method according to claim 6, wherein in step 3), the spatio-temporal fusion transformation module based on multi-task learning (51) comprises three parts: an input layer, a private-shared layer and a task output layer;
the input layer receives data of the tube bending process comprehensive information model IM (43), comprising the total data Data_{Mach} of the tube bending device die state monitoring part and the total data Data_{Tube} of the tube fitting bending process monitoring part;
the private-shared layer comprises a shared long short-term memory (LSTM) module and two private LSTM modules, and the two private LSTM modules are an auxiliary task private LSTM module and a main task private LSTM module; the shared LSTM module receives two parts of data: the total data Data_{Mach} of the tube bending device die state monitoring part, and the total data Data_{Tube} of the tube fitting bending process monitoring part; and the auxiliary task private LSTM module and the main task private LSTM module respectively receive the total data Data_{Mach} of the tube bending device die state monitoring part, and the total data Data_{Tube} of the tube fitting bending process monitoring part; and
the task output layer comprises an auxiliary task Dense module, a feature fusion Concatenate module and a main task Dense module; output results of the auxiliary task private LSTM module and the shared LSTM module are added element by element and input to the auxiliary task Dense module, output results of the main task private LSTM module and the shared LSTM module are added element by element and input to the feature fusion Concatenate module together with output results of the auxiliary task Dense module for serial splicing to realize feature fusion, and the fused data is input to the main task Dense module; and the auxiliary task Dense module and the main task Dense module respectively output the prediction result of the tube bending device state and the prediction result of tube fitting bending forming as the final output results of the module.

15. The real-time monitoring and prediction method according to claim 7, wherein in step 3), the spatio-temporal fusion transformation module based on multi-task learning (51) comprises three parts: an input layer, a private-shared layer and a task output layer;
the input layer receives data of the tube bending process comprehensive information model IM (43), comprising the total data Data_{Mach} of the tube bending device die state monitoring part and the total data Data_{Tube} of the tube fitting bending process monitoring part;
the private-shared layer comprises a shared long short-term memory (LSTM) module and two private LSTM modules, and the two private LSTM modules are an auxiliary task private LSTM module and a main task private LSTM module; the shared LSTM module receives two parts of data: the total data Data_{Mach} of the tube bending device die state monitoring part, and the total data Data_{Tube} of the tube fitting bending process monitoring part; and the auxiliary task private LSTM module and the main task private LSTM module respectively receive the total data Data_{Mach} of the tube bending device die state monitoring part, and the total data Data_{Tube} of the tube fitting bending process monitoring part; and
the task output layer comprises an auxiliary task Dense module, a feature fusion Concatenate module and a main task Dense module; output results of the auxiliary task private LSTM module and the shared LSTM module are added element by element and input to the auxiliary task Dense module, output results of the main task private LSTM module and the shared LSTM module are added element by element and input to the feature fusion Concatenate module together with output results of the auxiliary task Dense module for serial splicing to realize feature fusion, and the fused data is input to the main task Dense module; and the auxiliary task Dense module and the main task Dense module respectively output the prediction result of the tube bending device state and the prediction result of tube fitting bending forming as the final output results of the module.

16. The real-time monitoring and prediction method according to claim 8, wherein in step 3), the spatio-temporal fusion transformation module based on multi-task learning (51) comprises three parts: an input layer, a private-shared layer and a task output layer;
the input layer receives data of the tube bending process comprehensive information model IM (43), comprising the total data Data_{Mach} of the tube bending device die state monitoring part and the total data Data_{Tube} of the tube fitting bending process monitoring part;
the private-shared layer comprises a shared long short-term memory (LSTM) module and two private LSTM modules, and the two private LSTM modules are an auxiliary task private LSTM module and a main task private LSTM module; the shared LSTM module receives two parts of data: the total data Data_{Mach} of the tube bending device die state monitoring part, and the total data Data_{Tube} of the tube fitting bending process monitoring part; and the auxiliary task private LSTM module and the main task private LSTM module respectively receive the total data Data_{Mach} of the tube bending device die state monitoring part, and the total data Data_{Tube} of the tube fitting bending process monitoring part; and
the task output layer comprises an auxiliary task Dense module, a feature fusion Concatenate module and a main task Dense module; output results of the auxiliary task private LSTM module and the shared LSTM module are added element by element and input to the auxiliary task Dense module, output results of the main task private LSTM module and the shared LSTM module are added element by element and input to the feature fusion Concatenate module together with output results of the auxiliary task Dense module for serial splicing to realize feature fusion, and the fused data is input to the main task Dense module; and the auxiliary task Dense module and the main task Dense module respectively output the prediction result of the tube bending device state and the prediction result of tube fitting bending forming as the final output results of the module.

17. The method for real-time monitoring and prediction according to claim 13, wherein the spatio-temporal fusion transformation module based on multi-task learning (51) is trained by a joint loss function and adapted to multi-task learning scenarios, and the joint loss function is defined as a sum of a weight of a loss of auxiliary task of tube bending device die state L_{auxiliary} and a loss of main task of tube fitting bending process state Lₘₐᵢₙ:
$$L = {L}_{main} + α {L}_{auxiliary}$$
where Lis a total loss of the model and the weight a is determined according to the empirical method.

18. The method for real-time monitoring and prediction according to claim 14, wherein the spatio-temporal fusion transformation module based on multi-task learning (51) is trained by a joint loss function and adapted to multi-task learning scenarios, and the joint loss function is defined as a sum of a weight of a loss of auxiliary task of tube bending device die state L_{auxiliary} and a loss of main task of tube fitting bending process state Lₘₐᵢₙ:
$$L = {L}_{main} + α {L}_{auxiliary}$$
where L is a total loss of the model and the weight a is determined according to the empirical method.

19. The method for real-time monitoring and prediction according to claim 13, wherein in step 3):
the tube bending device die state and the tube fitting deformation state at the current time and the future time are predicted according to the tube bending device information and the tube bending state before the current time;
the tube bending device die state comprises an abnormal tube bending device state; and
the predicting the tube fitting deformation state comprises predicting a distortion defect of a tube fitting section.

20. The real-time monitoring and prediction method according to claim 13, wherein,
the tube bending device (1) may be compensated online according to the wrinkling corrugation directly measured by the sensor and the cross-section distortion defect obtained by prediction, and the compensation may be realized by speeding up or slowing down the speed of the bending die (6), the pressing die (9) and the boosting trolley (11) and increasing or decreasing the pressure of the pressing die (9) and the boosting trolley (11) on the tube fitting (2); and
the tube bending device (1) may be bent and compensated again online according to a rebound angle of the tube fitting (2) measured after bending and unloading.
